(19) United States
(12) Patent Application Publication
(10) Pub. No.: US 2004/0090672 A1
(43) Pub. Date: May 13, 2004

(54) Terrestrial telescope with digital camera

(76) Inventors: Yoshihide Goto, Gamagori-shi (JP); Takayuki Ishida, Gamagori-shi (JP); Shuichi Tominaga, Gamagori-shi (JP); Yasunari Ooguchi, Gamagori-shi (JP)

Correspondence Address: ADAMS & WILKS, 50 Broadway, 31st Floor, New York, NY, 10004, US

(21) Appl. No.: 10/323,375

(22) Filed: Dec. 19, 2002

(30) Foreign Application Priority Data
Nov. 8, 2002 (JP) 2002-324618

(51) Int. Cl. G02B 21/36; G02B 23/00; G03B 17/48; G03B 19/00; G03B 29/00

(52) U.S. Cl. 359/399; 359/363; 396/429

(57) ABSTRACT

A terrestrial telescope with a digital camera has a TTL light-measurement system for controlling the exposure. For this the imaging element for taking pictures is used to determine exposure control data in response to the first shutter operation. The exposure control data thus determined is used as a basis for controlling the following sequential picture-taking/recording processing in a speed mode until it is cancelled. The camera is able to take pictures in a continuous sequence in which the interval between pictures is very short.

### BACKGROUND OF THE INVENTION

1. Field of the Invention

The present invention relates to a terrestrial telescope with a digital camera that can take observed images digitally.

2. Description of the Prior Art

Terrestrial telescopes having a magnification factor ranging from about 20 to 60 are used extensively for observing wild birds and other fauna. Terrestrial telescopes include those based on a Galilean telescope configuration comprising a positive (convex) lens and a negative (concave) lens that functions as an erecting system, and those based on a Keplerian telescope configuration comprising just a positive (convex) lens, to which are added prisms or other such elements to constitute an erecting system. Both types of telescope enable a viewer to observe an erect image.

As well as being able to use such telescopes to observe natural flora and fauna, users want to be able to record the images they are seeing. In Japanese Patent Application No. 2002-47304, the present applicant proposed a configuration for a terrestrial telescope with a digital camera that is able to record an observed image. In this configuration the observed images are bright and clear because the images that are observed are spatial images.

Specifically, in the configuration of the above mentioned patent application, a prism is used to form an erect image of the objective lens at the position of a reticle, whose image can be viewed as a spatial image via an ocular. Also, a beam-splitter mirror is disposed on the optical path of the objective lens and a CCD is disposed at a position that is a conjugate of the erect image. During video imaging, the beam-splitter mirror is retracted out of the optical path, enabling the image data to be recorded on recording media via the CCD and image processing circuitry. This configuration enables a user to view spatial images produced by the objective lens without using conventional display means such as a focusing screen or LCD, and the observed images can be readily recorded as electronic images by using an imaging element located at a position that is a conjugate to that of the spatial image.

In a digital camera, exposure-has to be controlled by adjusting the drive conditions of the CCD or other imaging means, or the amplifier gain. This also applies in the case of a digital camera constituted as an integral part of a terrestrial telescope system. Depending on the product, this exposure control can be performed manually, but it is of course preferable for exposure control to be performed automatically.

It is preferable that the automatic exposure does not use an external light-measuring device or the like to measure the light, but instead uses the same means used for the imaging (a through-the-lens, or TTL system) and controls the exposure based on the result.

For example, an arrangement can be used whereby when the user uses the shutter button to execute the imaging, the imaging means is used to measure the light directly prior to the imaging segment and set the imaging conditions accordingly, to thereby perform optimum exposure control that minimizes the effect of fluctuations in lighting conditions and the like. Many digital cameras employ such a type of exposure control system.

When an imaging element such as a CCD is used both for measuring the light and for the imaging, such a problem arises that, during both light-measurement and imaging, a relatively long processing time is required for reading the pixel data from the imaging element and for clearing any unnecessary charge. With a configuration that simply performs light-measurement and imaging each time, it is not unusual for the imaging processing time per frame to be several hundred milliseconds, so it is difficult to shorten the minimum interval between imagings (the maximum number of images per unit time).

A configuration in which exposure control is performed using an external element for measuring the light can avoid the above problem, but has the problem that the exposure cannot be properly controlled to match the image because the external light-measurement element may not always reflect the brightness of the acquired image. A product such as a terrestrial telescope with a digital camera is often used to observe/take pictures of fast-moving objects such as birds, so users will want to be able to take pictures in sequences, that is, take pictures with a short interval between pictures. If the interval between pictures is too long, the product value can suffer.

An object of the present invention is therefore to provide a terrestrial telescope with digital camera that uses a TTL light-measurement system to provide appropriate exposure control and can take pictures continuously with a very short interval between exposures.

### SUMMARY OF THE INVENTION

A terrestrial telescope having a digital camera according to the invention comprises an optical system including an objective lens for forming an image of a subject and an erecting system for erecting the image of the subject so as to be observable as a spatial erect image, an imaging element disposed at a position that is a conjugate of the image-formation plane of the objective lens, means for switching over the image of the subject to the erecting system and to the imaging element, means for determining exposure using the imaging element in response to the first shutter operation at the time the imaging is initiated, and means for controlling the following sequential imaging based on the exposure determined by the first shutter operation without new exposure determination.

Further features of the invention, its nature and various advantages will be more apparent from the accompanying drawings and following detailed description of the invention.

### BRIEF DESCRIPTION OF THE DRAWINGS

FIG. 1 is an explanatory view showing the general configuration of a terrestrial telescope with a digital camera according to the present invention;

FIG. 2 is a timing chart showing the operation timing of each part of the apparatus of FIG. 1 in standard mode; and

FIG. 3 is a timing chart showing the operation timing of each part of the apparatus of FIG. 1 in speed mode.

### DESCRIPTION OF THE PREFERRED EMBODIMENT

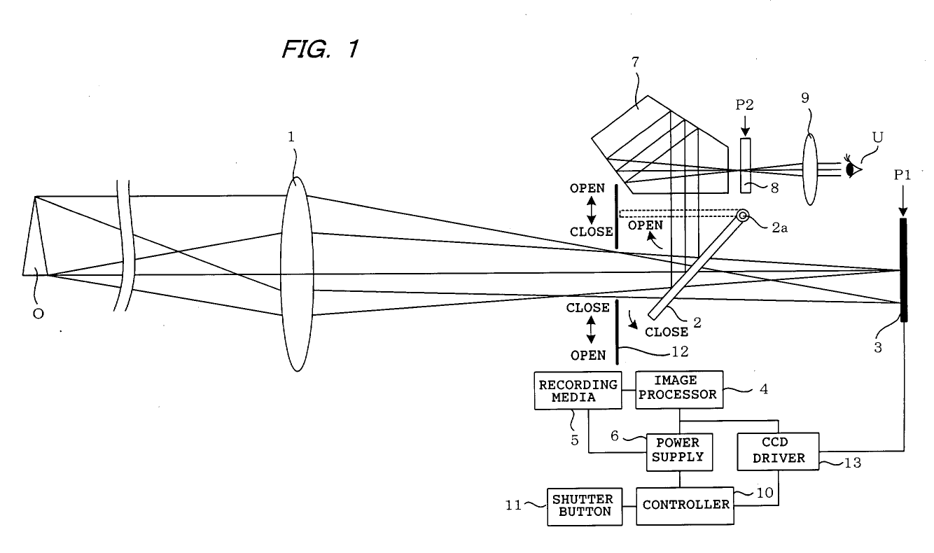

An embodiment of the invention will now be described with reference to the drawings. FIG. 1 shows the general configuration of a terrestrial telescope with a digital camera according to the present invention. In FIG. 1, reference numeral 1 denotes an objective lens. In FIG. 1, the objective lens 1 is shown as a single lens, but the configuration and drive system are arbitrary. The objective lens 1 can be a zoom lens that can be zoomed by an external operation. The zooming can be done using a motor drive or manually. The lens 1 can also be made focussable. The objective lens 1 has a focal distance that can be adjusted from 140 mm to 420 mm, for example.

A quick-return mirror 2 is provided on the optical axis of the objective lens 1, with the mirror 2 being set at an angle of 45 degrees to the optical path. The quick-return mirror 2 is supported so that it can rotate about an axis 2a. The mirror 2 is normally in the closed position indicated by the solid line, but during imaging a spring or other such drive means is used to retract the mirror 2 to the open position indicated by the broken line. Thus, the quick-return mirror 2 is operated by the same type of drive system used to operate the quick-return mirror of a single-lens reflex camera.

A mechanical shutter 12 is positioned in front of the quick-return mirror 2. The mechanical shutter 12 can be one having a diaphragm structure. The mechanical shutter 12 is located at the pupil position of the optical system. The mechanical shutter 12 does not have to be located in front of the quick-return mirror 2; depending upon design considerations, it can be positioned elsewhere, such as behind the quick-return mirror 2.

Also, the shutter 12 is referred to as a mechanical shutter simply to differentiate it from the electronic shutter of the CCD driver circuit 13 described below. The term “mechanical” is not intended to limit the shutter to one that is mechanically driven. Thus, the mechanical shutter 12 can be driven electrically or electronically by a solenoid or the like using an electrical or electronic control means.

Located behind the quick-return mirror 2 is a CCD 3 that constitutes the imaging element used for obtaining digital images. Images produced by means of the objective lens 1 are formed on the CCD 3 (image-formation position P1). Provided above the quick-return mirror 2 is a penta roof prism 7 that deflects the optical path horizontally. The penta roof prism 7 and quick-return mirror 2 function as an erecting optical system that forms a subject image produced by the objective lens 1 into an erect image.

A reticle 8 that shows the imaging range of the CCD 3 is provided at a position (image-formation position P2) that is a conjugate of that of the CCD 3. An ocular 9 having a focal distance in the order of 7 mm (the focal distance arbitrary) is disposed to the rear of the reticle 8. The ocular 9 can be moved back and forth along the optical axis to adjust the diopter.

The real image of a subject 0 (a wild bird, for example) is formed at the position of the reticle 8 and can be viewed by the user U using the ocular 9 as a virtual spatial image (erect image).

The driving of the CCD 3 is controlled by the CCD driver circuit 13. The CCD driver circuit 13 includes an electronic shutter circuit for controlling the sweeping of pixel data from the CCD 3. The electronic shutter of the CCD driver circuit 13 is opened during imaging segments and closed at other times. The CCD driver circuit 13 also includes an amplifier circuit for amplifying analogue image signals from the CCD 3. The CCD driver circuit 13 also performs light-measurement and clears any charge not required after the imaging. The drive timing of the electronic shutter circuit in the CCD driver circuit 13 and the gain of the amplifier circuit are controlled based on the result of the light measurement.

Under the control of the CCD driver circuit 13, image data from the CCD 3 is input to an image processing circuit 4, where the image data is processed so as to be written on recording media 5 as a JPEG or other such data file. The image processing circuit 4 has a known configuration, so a detailed description of the circuit 4 is therefore omitted. The image processing circuit 4 can also include other functions such as converting images to user-settable dimensions and color correction. The recording media 5 may be arbitrarily selected from among such storage media as memory cards, semiconductor cards, PC cards and flexible disks, and so forth.

Reference numeral 10 denotes a controller comprised of a microprocessor, memory, chip-sets and other such component parts. Under the control of the controller 10, in accordance with the operation of the shutter button 11, the quick-return mirror 2 is retracted, the mechanical shutter 12 is operated, the exposure is determined and images are obtained by the CCD 3, processed and recorded on recording media 5. The system is able to detect the difference between half and full depression of the shutter button 11. Reference numeral 6 denotes a power supply used to drive the above electronic circuitry. The power supply 6 is usually a battery or the like.

The operation of the system will now be described, with specific reference to the observation and imaging operations. First, the ocular 9 is adjusted for the diopter of the user. This is done by adjusting oculars until the user can clearly see the field-of-view frame of the reticle 8 or a pattern. The optical system is designed so that when the diopter adjustment has been completed and the image viewed through the ocular 9 is clear, a clear image can also be formed on the CCD 3.

A subject 0 can be observed as follows. In observation mode, the mechanical shutter 12 remains open and the quick-return mirror 2 is controlled to move to the closed position indicated in FIG. 1 by the solid line. The objective lens 1 is assumed to be a zoom lens and the apparatus is being used for birdwatching (in the following explanation, the subject 0 is assumed to be a bird). First, the user points the telescope at the bird with the objective lens 1 set to the shortest focal distance. The light entering the objective lens 1 is deflected upward by the quick-return mirror 2 and horizontally by the penta roof prism 7, and forms an erect image on the reticle 8. Through the ocular 9, the image can be viewed at a magnification of 20x. The image of the subject bird can be magnified by increasing the focal distance of the objective lens 1 while keeping the bird in the center of the field of view. If desired, an image of the bird at this point can be recorded by pressing the shutter button 11.

The controller 10 then drives a solenoid or other such drive element (not shown) to retract the quick-return mirror 2 to the open position shown by the broken line, allowing input of image data from the CCD 3 and enabling the image data to be written to the recording media 5 by the image processing circuit 4. This embodiment provides a standard imaging mode and a speed imaging mode. Details of the two modes are described later.

The image processing circuit 4 records the image of the subject bird on the recording media 5. Since the quick-return mirror 2 is now in the open position (shown by the broken line) during the imaging process, the image cannot be viewed through the ocular 9. Observation of the image can be resumed after the image data has been acquired via the CCD 3 because the quick-return mirror 2 is returned automatically to the closed position (shown by the solid line).

In accordance with the configuration of this embodiment, an ocular 9 is provided to enable an erect image of the subject formed at the position of the reticle 8 to be observed as a spatial image. At the same time, the quickreturn mirror 2 can be retracted out of the optical path during imaging. This enables the observed image data to be acquired by means of the CCD 3 located at a position that is a conjugate of the reticle 8 and the image data to be recorded on recording media 5. This thus makes it possible to obtain the bright, clear images during observation as is usual in a standard terrestrial telescope and also to readily record the observed images as electronic images.

Unlike in a conventional system using a single-lens reflex camera in which the observed image is formed on a focusing screen, or unlike in a conventional system using a digital camera in which the image is viewed on a display device such as an LCD, the present invention makes it possible to directly observe spatial images formed by an objective lens (and a suitable erecting system), so the image is sharp and bright and can be immediately retained on recording media in the form of digital image data.

Details of the standard and speed imaging modes will now be described.

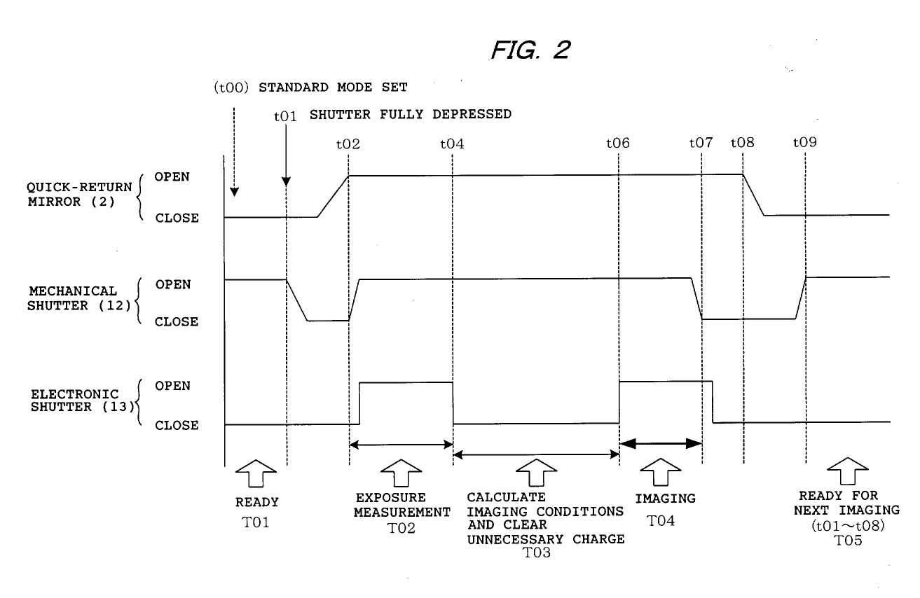

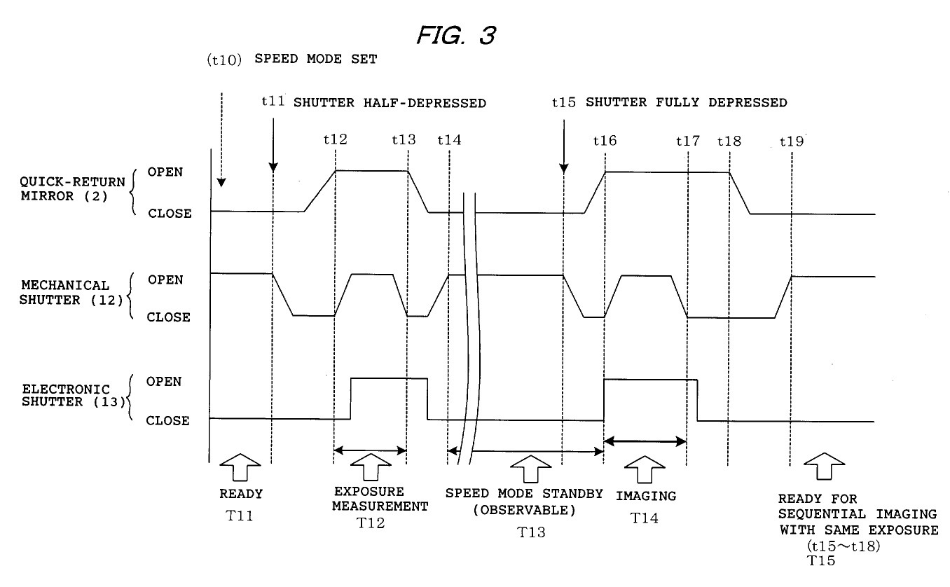

FIG. 2 is a timing chart showing the operation timing of each part in standard mode, and FIG. 3 is a timing chart showing the operation timing of each part in speed mode. The desired mode can be selected by using an appropriate mode-setting means provided on a panel (not shown).

The control of the standard mode is based on digital still processing used in usual digital cameras having a mechanical shutter and quick-return mirror. Standard-mode control is effected after the standard mode has been set (t00). In the imaging ready state (T01), the shutter button 11 is fully depressed at time t01. The quick-return mirror 2 is then moved from the closed position to the open position (t02), at which timing light-measurement (exposure) control is initiated. In the timing segment t01 to t02, the mechanical shutter 12 is temporarily closed (not essential) to prevent flickering of the observed image accompanying the movement of the quick-return mirror 2 being seen via the ocular 9.

Exposure measurements are carried out via the TTL (T02; t02 to t04) using the CCD 3 that is used for the image acquisition. The electronic shutter of the CCD driver circuit 13 is opened, the CCD driver circuit 13 sweeps out the CCD 3 pixel data and the electronic shutter is closed (t04). The image data is subjected to A/D conversion and to other data conversion, if required, and is output to the controller 10 as measured-light data. Based on the measured-light data thus input, the controller 10 sets the drive timing for the electronic shutter of the CCD driver circuit 13 and other required imaging conditions such as amplifier circuit gain. These calculations are initiated as soon as the measured-light data is received from the CCD driver circuit 13.

The segment T03 of FIG. 2 is required to enable the controller 10 to perform the setting of the remaining imaging conditions based on the measured-light data, and to enable the CCD driver circuit 13 to clear any unnecessary charge on the CCD 3. Following this, the actual imaging takes place in imaging time segment T04 (t06 to t07). Here, the CCD 3 is controlled by the CCD driver circuit 13 in accordance with imaging conditions data (exposure control data) set by the controller 10. Based on the imaging conditions data (exposure control data) set by the controller 10, the electronic shutter is again opened, CCD 3 pixel data is swept out, subjected to A/D conversion and output to the image processing circuit 4. The image processing circuit 4 converts the received data to a data format such as JPEG, and records the converted data onto the recording media 5.

The timing (t08) for the return of the quick-return mirror 2 to the closed position can be set by the controller 10 in accordance with the ending of the imaging time segment T04. The mechanical shutter 12 is also closed from t08 to t09 to suppress flickering of the observed image.

Standard-mode imaging is carried out in this way. As can be seen from FIG. 2, during light-measurement control (T02) and imaging (T04), the quick-return mirror 2 is held in the open position shown in FIG. 1, so that during those times the ocular 9 cannot be used for observation. Prior to the above imaging (T04), a period (up to t06) is required for light-measurement control (T02) and the following clearing of any unnecessary charge. With this system the cycle of FIG. 2 is repeated each time the shutter button 11 is operated, so that the minimum interval to the next imaging cannot be decreased to less than the time required to process one of the cycles shown in FIG. 2.

Even with high-speed elements and processing circuits, there is a limit to the extent to which users' demands can be met with respect to sequential image acquisition of a rapidly-moving subject. In such a case, the speed mode of FIG. 3 can be selected. With reference to the timing and segment reference symbols for FIG. 3, T01 to T05 and t00 to t09 of FIG. 2 have been changed to T11 to T15 and t10 to t19. For clarity, only what is important is explained. For parts and operations that are the same as in FIG. 2, the same explanation applies.

The speed mode of FIG. 3 is characterized by the fact that after the speed mode is set (t10), light-measurement control (T12) is effected just once by the first half-depression of the shutter button 11, and the imaging conditions data (exposure control data) remains in force for any image acquisition until the speed mode is cancelled. With such an arrangement the light-measurement control (T12) required prior to the imaging (T14) in the standard mode of FIG. 2 and the subsequent period for clearing any leftover charge are no longer needed except for the first imaging following selection of the speed mode. This makes it possible to greatly shorten the minimum interval before the next image acquisition.

Moreover, the quick-return mirror 2 returns to the closed position in the time segment T13 following the completion of the exposure determination (speed mode standby state) and the mechanical shutter 12 is kept open, which makes it possible for a user using the ocular 9 to continue to observe the subject image of the sequential acquisition operation.

In the case of the timing shown in FIG. 3, the mechanical shutter 12 is also operated to suppress flickering of the observed image when the quick-return mirror 2 is moved. However, the moving of the quick-return mirror 2 to the closed position (t13) and the moving of the mechanical shutter 12 to the open position (t14) before the speed mode standby state (T13) are done at the completion of the exposure control data calculations by the controller 10 and of the clearing of any remaining charge by the CCD driver circuit 13.

After the system has entered the speed mode standby state (T13), the shutter button 11 is fully depressed at the required time (t15) for imaging to be performed immediately using the exposure conditions data set by the first half-depression of the shutter button 11 without conducting the exposure measurement from t15. That is, if the shutter button 11 is fully depressed when the system enters the imaging ready state at t15 or t19, imaging can be performed immediately using the exposure conditions data set by the first half-depression of the shutter button 11 without conducting the exposure measurement from t15. This (speed/sequential) imaging implemented by fully depressing the shutter button 11 can be repeated until the speed mode is cancelled.

Compared to the standard mode, the speed mode of FIG. 3 makes it possible to shorten the minimum imaging interval, starting from the second interval, by an amount that corresponds to the time used for light-measurement control (T12) and charge clearance, which can be in the order of several tens to several hundred milliseconds, depending on the hardware. If, for simplicity, the light-measurement and imaging processing times are assumed to be more or less the same, it would mean that in speed mode, approximately twice the number images can be acquired. Moreover, for the same reasons, the required per-frame extinction time for an image observed via the ocular 9 (t15 to t19 corresponding to the retraction period of the quick-return mirror 2) is also greatly decreased, providing a marked improvement in operability during the imaging.

The above explanation has been made with reference to light-measurement control that would delay just the first imaging operation in speed mode. However, in most actual picture-taking applications this delay does not pose a problem. In birdwatching, for example, a subject bird has already been captured in the field of view and the movement of the bird is predicted. In such situations the speed mode is set and the shutter button 11 is half-depressed to determine the exposure. The shutter button 11 is then fully depressed repeatedly (or keeping the shutter button 11 fully depressed) when the subject just begins to move. In such a general case, a delay in acquiring the first image in a sequence does not pose a problem.

A special means can be used for selecting standard or speed mode. Since it is desirable to be able to quickly set (or cancel) the speed mode, a special operating mode can be used to enable the shutter button 11 to be used to quickly set (or cancel) the mode. For example, the shutter button 11 could be pressed a plurality of times to set (or cancel) the speed mode, making it possible to very quickly change to speed mode or back to standard mode while continuing to observe the subject and without the user having to change his or her grip on the camera.

As described in the foregoing, in addition to a standard imaging mode, the terrestrial telescope with a digital camera according to the present invention is also provided with a speed mode that enables more pictures to be taken in a much shorter time than is possible in standard mode.

The optical system described in the context of the foregoing embodiment is only one example, and the components or elements can be changed by a person skilled in the art. For example, another optical system can be used to form the erecting optical system instead of the above-described combination of penta roof prism and quick-return mirror. Also, as mentioned, the placement and mechanical composition of the mechanical shutter (and other shutter systems including, for example, focal plane shutters), and the composition of the objective optical system (whether to configure it as a zoom system or not) are also arbitrary.

As described in the foregoing, an excellent terrestrial telescope with a digital camera is provided in accordance with the present invention in which the imaging element is used to determine exposure control data in response to the first shutter operation in a speed mode. The exposure control data thus determined is used as a basis for controlling the picture-recording processing by the picture-recording means until the speed mode is cancelled. A TTL system can therefore be used to provide optimum exposure control. The invention thus configured is able to continuously take many more pictures in a given time than a conventional system.

What is claimed is:

1. A terrestrial telescope having a digital camera comprising:
an optical system including an objective lens for forming an image of a subject and an erecting system for erecting the image of the subject so as to be observable as a spatial erect image;
an imaging element disposed at a position that is a conjugate of the image-formation plane of the objective lens;
means for switching over the image of the subject to the erecting system and to the imaging element;
means for determining exposure using the imaging element in response to the first shutter operation at the time the imaging is initiated; and
means for controlling the following sequential imaging based on the exposure determined by the first shutter operation without new exposure determination.

2. A terrestrial telescope having a digital camera according to claim 1, further comprising means for controlling the imaging based on the exposure determined for each shutter operation.

3. A terrestrial telescope having a digital camera according to claim 2, comprising means for selecting a mode in which the imaging is performed based on the exposure determined by the first shutter operation without new exposure determination and a mode in which the imaging is performed based on the exposure determined for each shutter operation.
